(19) United States
(12) Patent Application Publication
(10) Pub. No.: US 2017/0063551 A1
(43) Pub. Date: Mar. 2, 2017

(54) SYSTEM AND METHOD FOR SECURELY MANAGING INTEGRITY-VERIFIABLE AND AUTHENTICABLE INFORMATION

(71) Applicant: Snapfile Ltd., Dublin (IE)

(72) Inventors: Malachy Quinn, Dublin (IE); Edward Williams, Cheshire (GB); Thomas Davenport, Birmingham (GB); Vincent Furlong, Dublin (IE); Wendy Williams, Dublin (IE)

(21) Appl. No.: 14/808,791

(22) Filed: Jul. 24, 2015

Related U.S. Application Data
(60) Provisional application No. 62/029,275, filed on Jul. 25, 2014.

(51) Int. Cl. H04L 9/32; H04L 29/06; H04W 12/06; H04L 9/06

(52) U.S. Cl. CPC H04L 9/3247; H04L 9/0643; H04L 63/08; H04W 12/06

(57) ABSTRACT

Methods and systems for securely storing information in an accessible and a tamper-evident manner are disclosed. Exemplary systems and methods encrypt the information and store the encrypted information in a tamper-evident manner. Exemplary systems can additionally allow users to review, verifiably edit, organize, and manage flow of the information.

### CROSS REFERENCE TO RELATED APPLICATION

This application claims priority to U.S. Provisional Patent Application No. 62/029,275 filed Jul. 25, 2014 and entitled “SYSTEM AND METHOD FOR SECURELY MANAGING INTEGRITY-VERIFIABLE AND AUTHENTICABLE INFORMATION,” the respective disclosure of which is incorporated herein by reference.

### FIELD OF DISCLOSURE

The present disclosure generally relates to information storage systems and methods. More particularly, the disclosure relates to systems and methods for securely managing authenticable information.

### BACKGROUND OF THE DISCLOSURE

Systems and methods for storing and managing information are desirable for several reasons. Such systems can allow users to upload, review, and revise information and to collaborate using the information. These systems often do not store the information in a secure manner, which is verifiable, while allowing users to review and/or edit the information in a temper-evident manner. Accordingly, improved systems and methods for securely providing verifiable information in a tamper-evident manner are desired.

### SUMMARY OF THE DISCLOSURE

Various embodiments of the present disclosure relate to methods and systems for securely storing information in a tamper-evident manner. While the ways in which various embodiments of the present disclosure address drawbacks of prior information storage systems and methods are discussed in more detail below, in general, exemplary systems and methods encrypt the information and store the encrypted information in a tamper-evident manner. Exemplary systems can additionally allow users to review, verifiably edit, organize, and manage flow of the information. Additional exemplary features of exemplary systems and methods are discussed in more detail below.

### BRIEF DESCRIPTION OF THE DRAWING FIGURES

A more complete understanding of exemplary embodiments of the present disclosure can be derived by referring to the detailed description and claims when considered in connection with the following illustrative figures.

FIG. 1 illustrates a system in accordance with exemplary embodiments of the disclosure.

FIGS. 2-4 illustrate exemplary methods in accordance with various embodiments of the disclosure.

FIGS. 5-12 illustrate exemplary client and application screen shots and user interfaces in accordance with further exemplary embodiments of the disclosure.

FIG. 13 illustrates exemplary file formats suitable for use with exemplary embodiments of the disclosure.

FIG. 14 illustrates a method of using exemplary systems and methods in accordance with the present disclosure.

It will be appreciated that elements in the figures are illustrated for simplicity and clarity and have not necessarily been drawn to scale. For example, the dimensions of some of the elements in the figures may be exaggerated relative to other elements to help to improve the understanding of illustrated embodiments of the present disclosure.

### DETAILED DESCRIPTION OF EXEMPLARY EMBODIMENTS OF THE DISCLOSURE

The description of exemplary embodiments provided below is merely exemplary and is intended for purposes of illustration only; the following description is not intended to limit the scope of the disclosure or any claims. Moreover, recitation of multiple embodiments having stated features is not intended to exclude other embodiments having additional features or other embodiments incorporating different combinations of the stated features.

The present disclosure generally relates to systems and methods for securely storing information in an accessible and tamper-evident manner. The systems and methods can be used to securely store, organize, and manage the information. As set forth in more detail below, the systems and methods described herein can be used in a variety of project management applications. In these cases, the methods and systems can be used to record various (e.g. all) aspects of a project from start through to completion; allocate tasks to staff members, share data with colleagues, contract work to third parties; provide consistency regardless of how many people and companies are involved in the chain; control an amount and type of data fields added to each stage of a project; and measure subcontractor performance against agreed service level agreements (SLAs). The systems and methods can be used by contractors, human resources personnel, suppliers, account managers, legal professionals, medical professionals, area and site management personnel, procurement personnel, and the like, and can be tailored for specific applications. Several other exemplary applications are discussed below.

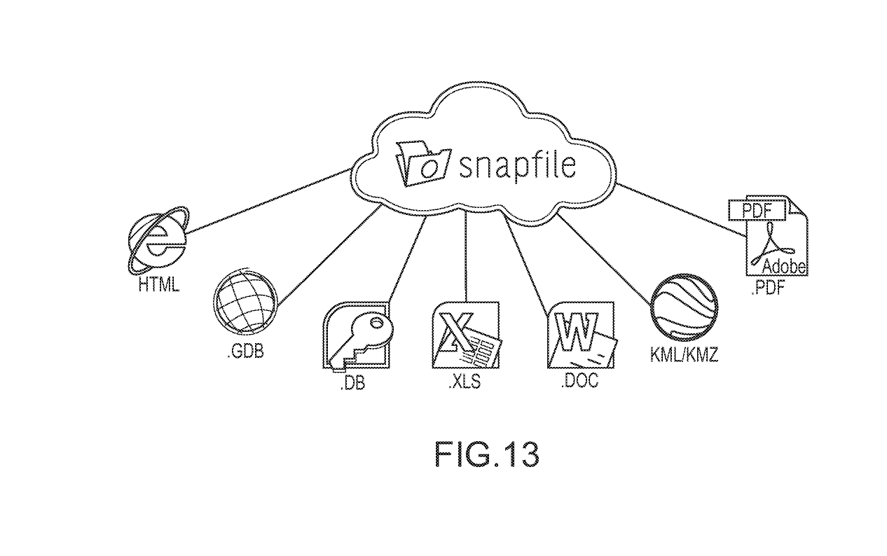

As used herein, information includes digital information, such as photographs, documents, video recordings, and the like. The information can be in a variety of formats, including HTML, .GDB, .DB, .XLS, .DOC, KML/KMZ, and/or .PDF, as illustrated in FIG. 13.

In accordance with various exemplary embodiments, the methods and systems described herein can be used to access information remotely. By way of examples, information can be accessed via any modern browser, application, plugin, or the like on a device, such as smartphone, wearable, tablet or laptop, or desktop computer.

Exemplary systems and methods can be used to reduce errors in stored information and increase efficiency by allowing users to access standardized, accurate and up-to-date project information whenever and wherever it is needed.

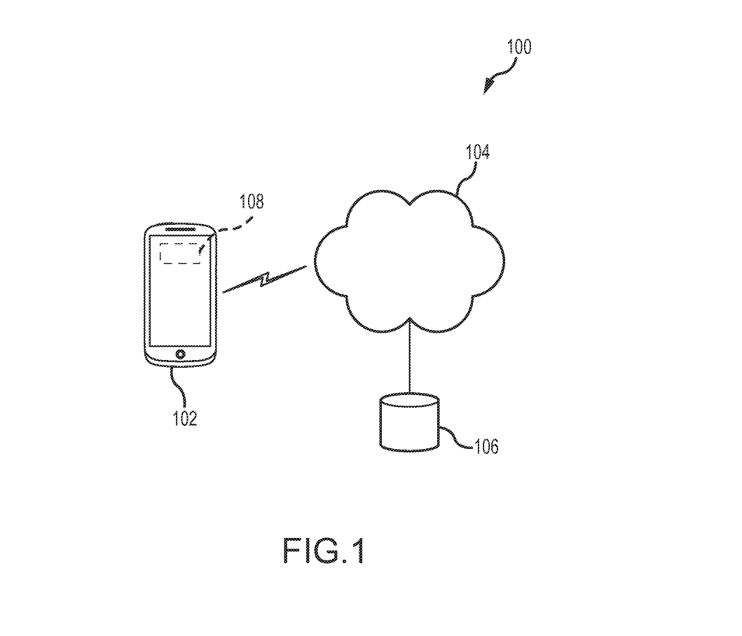

FIG. 1 illustrates a system 100 in accordance with exemplary embodiments of the disclosure. In the illustrated example, system 100 includes one or more devices 102, a network 104, and a server 106.

Device 102 can be any suitable device, including a mobile phone, a smart phone, a wearable device, a tablet computer, a laptop computer, a desktop computer, a digital camera, or the like. The device may include a user interface. The user interface may include any number of input devices to receive commands, data, and other suitable input from a user, as well as any number of output devices to provide the user with data, notifications, and other suitable information from the device. Any number of input devices may be included in the user interface such as a touch pad, a touch screen, and/or an alphanumeric keypad to allow a user to enter instructions and data into the device. The user interface may be configured to detect pressure exerted by a user on the keys of a keypad or a screen, as well as the time interval between key presses in order to determine if the current user is authorized to use the device. The user interface may also include a microphone to allow the user to provide audio data to the device, as well as a camera to allow the device to capture still or video images. The device may include speech recognition software to process oral input through the user interface. The user interface may also include any number of suitable output devices, such as a display screen to visually display information (such as video and text), and/or a speaker to provide auditory output. The device may be configured to provide words, phrases, tones, recorded music, or any other type of auditory output to a user through the speaker. The user interface can be activated to provide information and/or hinder the operation of the object.

Device 102 may include one or more biometric devices configured to receive biometric information, such as a fingerprint scanner, an iris scanner, a retinal scanner, and/or a breath analyser. Input devices such as a microphone or camera may also be utilized to perform biometric analyses, such as a voice analysis or facial recognition.

Software to implement methods of certain embodiments can be (1) installed on, or (2) downloaded onto a device indirectly or directly at any time by an authorized user through the Internet, short message service (SMS) text message, or in any other suitable manner and at any suitable time for carrying out a method according to certain embodiments. For example, the software may be installed on the device when purchased or downloaded after the device is purchased.

In certain embodiments, device 102 includes a wireless transceiver to communicate with other systems and devices through a wireless system such as a wireless mobile telephony network, General Packet Radio Service (GPRS) network, wireless Local Area Network (WLAN), BlueTooth®, Global System for Mobile Communications (GSM) network, Personal Communication Service (PCS) network, Advanced Mobile Phone System (AMPS) network, Infrared (IR), Near Field Communication (NFC), Wi-Fi®, IEEE 102.11 network, a Worldwide Interoperability for Microwave Access (WiMax) network, a microwave network, and/or a satellite communication network. Devices may also communicate with other systems and devices through any other type of connection, such as a wired Internet connection, a wireless Internet connection, a cellular telephone network connection, a wireless LAN connection, a wireless WAN connection, an optical connection, a USB connection, a mobile device synchronization port connection, a power connection, and/or a security cable.

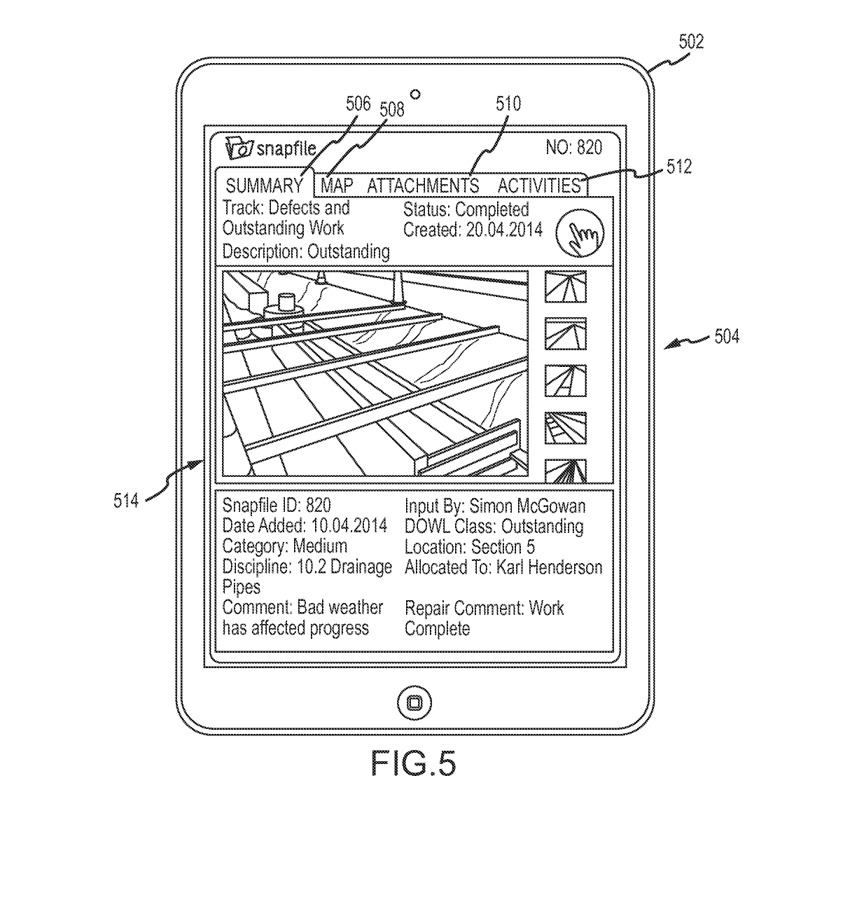

In accordance with exemplary embodiments, device 102 includes an application, plug-in, or similar software (generally referred to herein as application) 108 that can act as a client. Application 108 can allow a user to obtain information to be securely stored on server 106. Application 108 can also allow a user to associate additional information with the information (e.g., document, photo, video, or the like) to be stored. Exemplary applications allow for customized forms that can be tailored for a particular use. By way of examples, a number (e.g., up to 24 or more) data fields can be provided for each information file (also referred to herein as a “snapfile” or simply “file”). Exemplary screen shots and graphical user interfaces (GUI) of exemplary applications in accordance with exemplary embodiments of the disclosure are illustrated in FIGS. 5-12.

Device 102 may include a read-only memory and/or a random access memory (RAM). For purposes of the present application, a read only memory (also known as a “ROM”) includes not only non-modifiable memories such as mask ROMs and one-time programmable PROMs, but also persistent memories that may not be directly or indirectly modified through the user interface of a device. Such persistent memories may include such storage devices such as field programmable ROMs, EPROMs, EEPROMs, FLASH memory, magnetic storage devices, optical storage devices, or other storage devices. In certain embodiments, an application may reside in a read-only memory of the device. Both RAM and ROM may be considered as example of non-transitory computer-readable media.

A processor (e.g., as part of device 102) may retrieve and execute instructions stored in a memory to control the operation of device 102. Any number and type of processor such as an integrated circuit microprocessor, microcontroller, and/or digital signal processor (DSP), can be used in conjunction with certain embodiments. The memory stores instructions, data, messages transmitted from (or received by) the device, and any other suitable information. A memory operating in conjunction with certain embodiments may include any combination of different memory storage devices, such as hard drives, random access memory (RAM), read only memory (ROM), FLASH memory, or any other type of volatile and/or nonvolatile memory. Data can be stored in the memory in any desired manner. In certain embodiments, for example, data stored within the memory is partitioned into one or more logically disjointed groups. Each of the data groups can be encrypted with a respective unique encryption key to prevent all the data on the device from being accessed if a single encryption key is compromised. This also increases the time it will take a “brute force” attempt to try all possible encryption keys to succeed. The groups of data can be partitioned across a plurality of physical storage media, such a RAID array.

Network 104 can include a local area network (LAN), a wide area network, a personal area network, a campus area network, a metropolitan area network, a global area network, or the like. Network 104 can be coupled to one or more devices 102 using an Ethernet connection, other wired connections, a WiFi interface, other wireless interfaces (e.g., cell or mobile phone), or the like. Network 104 can be coupled to other networks and/or to other devices.

A communications interface may communicate with one or more servers or other suitable entities. Any suitable communications device, component, system, and method may be used in conjunction with certain embodiments. For example, the wireless transceiver may be configured to communicate using any number and type of cellular protocols, such as General Packet Radio Service (GPRS), Global System for Mobile Communications (GSM), Enhanced Data rates for GSM Evolution (EDGE), Personal Communication Service (PCS), Advanced Mobile Phone System (AMPS), Code Division Multiple Access (CDMA), Wideband CDMA (W-CDMA), Time Division-Synchronous CDMA (TD-SCDMA), Universal Mobile Telecommunications System (UMTS), and/or Time Division Multiple Access (TDMA). A device operating in conjunction with certain embodiments may alternatively (or additionally) include wireless transceiver(s) (and related components) to communicate using any other method of wireless communication protocol, such as an ISO 14443 protocol, an ISO 18000-6 protocol, a Bluetooth protocol, a Zigbee protocol, a Wibree protocol, an IEEE 802.15 protocol, an IEEE 802.11 protocol, an IEEE 802.16 protocol, an ultra-wideband (UWB) protocol, an IrDA protocol, and combinations thereof. The antenna may be configured to transmit and receive any wireless signal in any format, and may comprise a plurality of different antennas to transmit and receive information using different wireless protocols.

Device 102 (e.g., a communications module of device 102) can communicate with the server or another device using any other form of connection, such as a wired Internet connection, a wireless Internet connection, a cellular telephone network connection, a wireless LAN connection, a wireless WAN connection, an optical connection, a USB connection, a mobile device synchronization port connection, a power connection, and/or a security cable. The communications module can be used to communicate with one or more companion devices to monitor a position or status of objects.

Server 106 can be used to securely store information uploaded by a user using device 102. Server 106 can include one or more (e.g., dedicated) computers. During operation of system 100, users can use a device 102 to upload and/or retrieve information to/from server 106.

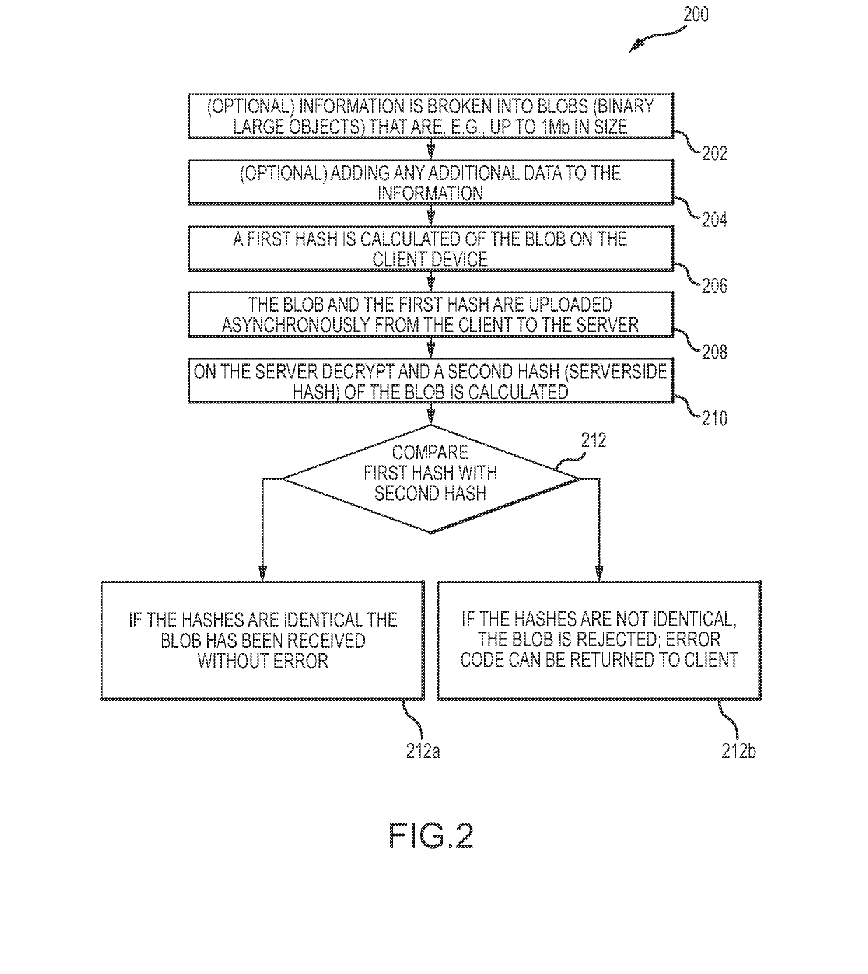

FIG. 2 illustrates an exemplary method 200 in accordance with further embodiments of the disclosure. Method 200 can be used to procure and upload information onto a server, such as server 106. The information can be saved as information files, which are containers for digital information. Anything that can be stored on a computer may be included in an information file. In accordance with exemplary embodiments, when an information file is created a signature is calculated of the information file data and metadata. In accordance with exemplary embodiments, each time an information file is viewed, the latest signature can be verified. Further, each time an information file is modified a new signature, which incorporates any previous signatures, can be created, so that an automatic and verifiable audit trail of the information file lifecycle is created.

Method 200 includes the steps of optionally breaking information into smaller packets or blobs (step 202), optionally adding additional information/data (step 204), calculating a first or clientside hash for the information (step 206), asynchronously uploading of the information and the clientside hash (e.g., not using http headers) (step 208), decrypting the information on the server and calculating a severside or second hash (step 210), and comparing the serverside hash with the clientside hash (step 212).

During step 202, digital information is optionally broken into smaller blobs. Data that is uploaded from a mobile device may be subject to dropout or corruption. To combat this, it may be desirable to break up the information during step 202.

At step 204, additional information or data, such as information that is not automatically captured or that a user may wish to manipulate can be added to the information. As used herein, data and information are synonymous.

During step 206 a hash value is calculated for the information (illustrated as performed on a blob; however, such is not necessarily the case). This is called the clientside hash. Hashes can be, for example, 16 or 20 bytes long so they do not add much to the data or information that is to be uploaded. Any suitable technique can be used to calculate the hash value.

At step 208, the information and the clientside hash are asynchronously uploaded and stored in a digital file or container (sometimes referred to herein as a snapfile or information file). The clientside hash and the serverside are then compared (step 212), and if the hash values match, the information has been received without error (step 212a). If the hash values do not match, then the client can receive a message and the information/information file can be destroyed and/or false information can be provided.

When the information to be uploaded includes, for example, photographs or video, an additional layer of security can be added to the information files. Images or video can be resized and/or can be watermarked with a visible watermark and/or an invisible watermark. The invisible watermark can include or be a digital signature (e.g., RSA or ESA) of the image that is saved in, for example, an Exif data of the image. The signature can be inserted on the server as the information file is being created.

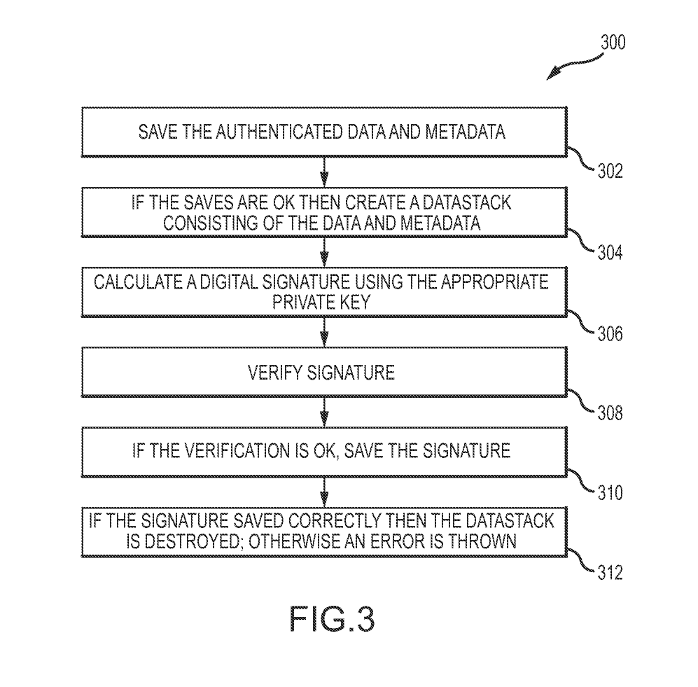

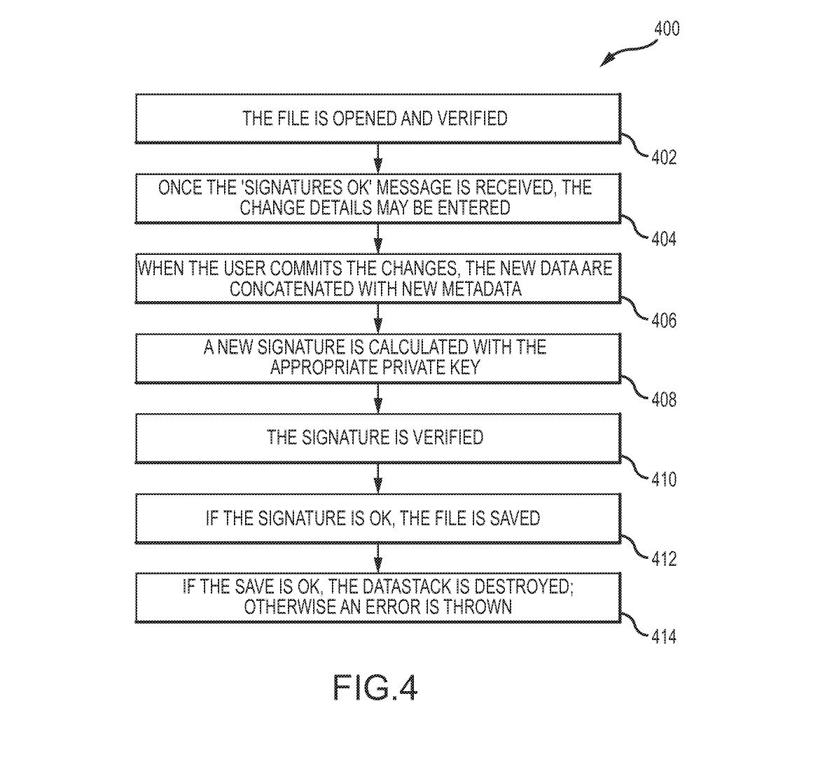

FIG. 3 illustrates a method 300 of forming an information file. Method 300 includes the steps of saving the authenticated data and metadata (e.g., information verifiably uploaded using method 200) (step 302), if the saves are okay then creating a datastack consisting of the data and metadata (step 304), calculate a digital signature using an appropriate private key (the key may be, for example, a general private key owned by the organisation or a specific private key owned by an individual) (step 306), verifying the signature (step 308), saving the signature if the verification is okay (step 310), and if the signature saved correctly then the datastack is destroyed otherwise an error is thrown (step 312).

In accordance with some embodiments of the disclosure, every time an information file is viewed, the chain of signatures is verified. If all the signatures are valid, a ‘Data OK’ message is displayed. If not, an error message is displayed and the information file is closed.

FIG. 4 illustrates a method 400 for editing an information file. Method 400 includes the steps of the information file is opened and verified (step 402), once the signatures are verified and a corresponding message is received the change details may be entered (step 404), when a user commits the changes, the new data are concatenated with new metadata (e.g., date, time, location and username) and the last digital signature (step 406), a new signature is then calculated with the appropriate private key (step 408). As before, the key may be an organisation key or an individual authorised user key. The signature is then verified (step 410). If the signature is OK is it saved (step 412). If the save is OK the datastack is destroyed; otherwise an error is thrown (step 414).

As noted above, methods and systems as described herein can be tailored for various applications. FIGS. 5-12 illustrate exemplary screen shots and/of GUIs from devices using exemplary systems and methods. As illustrated in the figures, an exemplary application (client) allows a user to capture information (e.g., a photo or a video), and to add additional information corresponding to the captured information. The information can then be edited using an application, as set forth herein.

FIG. 5 illustrates a device 502 including an application thereon that causes to be displayed image 504. In the illustrated example, image 504 is part of a GUI that allows a user of device 502 to perform various functions as described herein. The GUI illustrated in FIG. 5 includes tabs 506-512. Summary tab 506 is selected in the illustration. In this case, summary information 514 corresponding to an information file (snapfile) is presented as part of image 504.

In accordance with some embodiments of the disclosure, device 502 is part of an enterprise level data management system. In these cases, authorised users can create a file using photos and data entered into pre-set form fields. The information is secured using multiple layers of encryption, as described herein. This encryption makes a file tamper-evident. A user can then update and/or track progress using device 502 and the application.

When logging an event—e.g., using device 502, scheduling work or notifying co-workers of defects, it can be important that the location is precise. The application described herein can act as a GIS tool, using mobile mapping technology to geo-locate observations with high-level accuracy. Locations can be viewed in, for example, Google Street View or map view and can be adjusted by a user if desired.

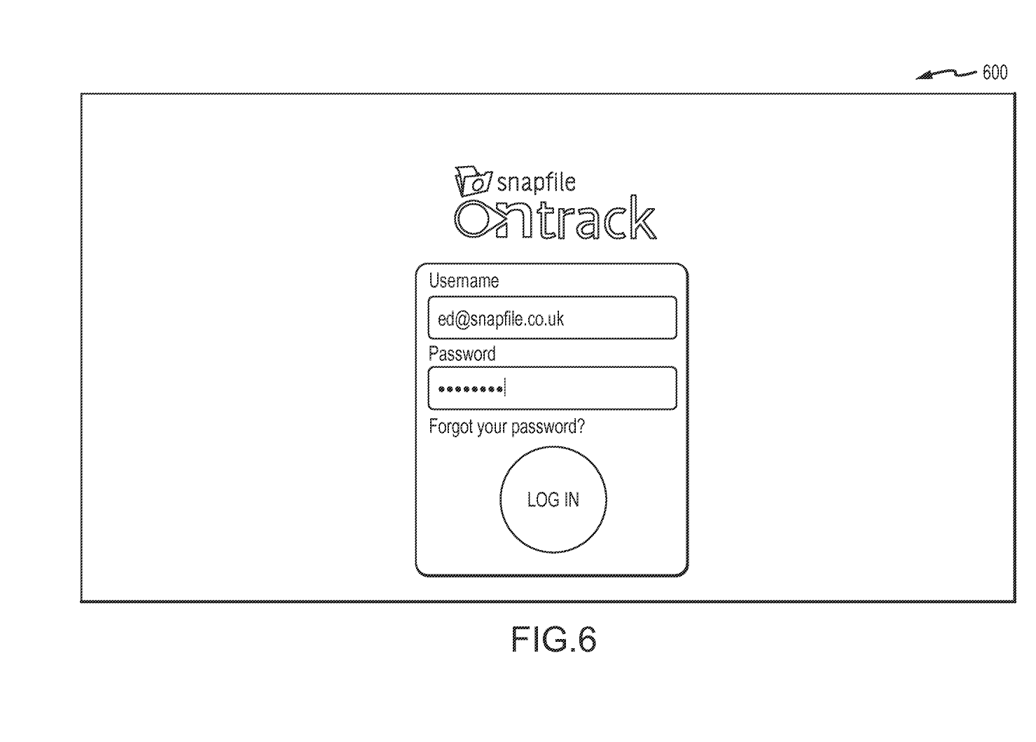

FIG. 6 illustrates a login screen 600. Login screen 600 can be used to require a password to access information by authorized users. An account manager or user with suitable credentials can authorize users. The account manager can allocate usernames and passwords or users may select a username and/or password.

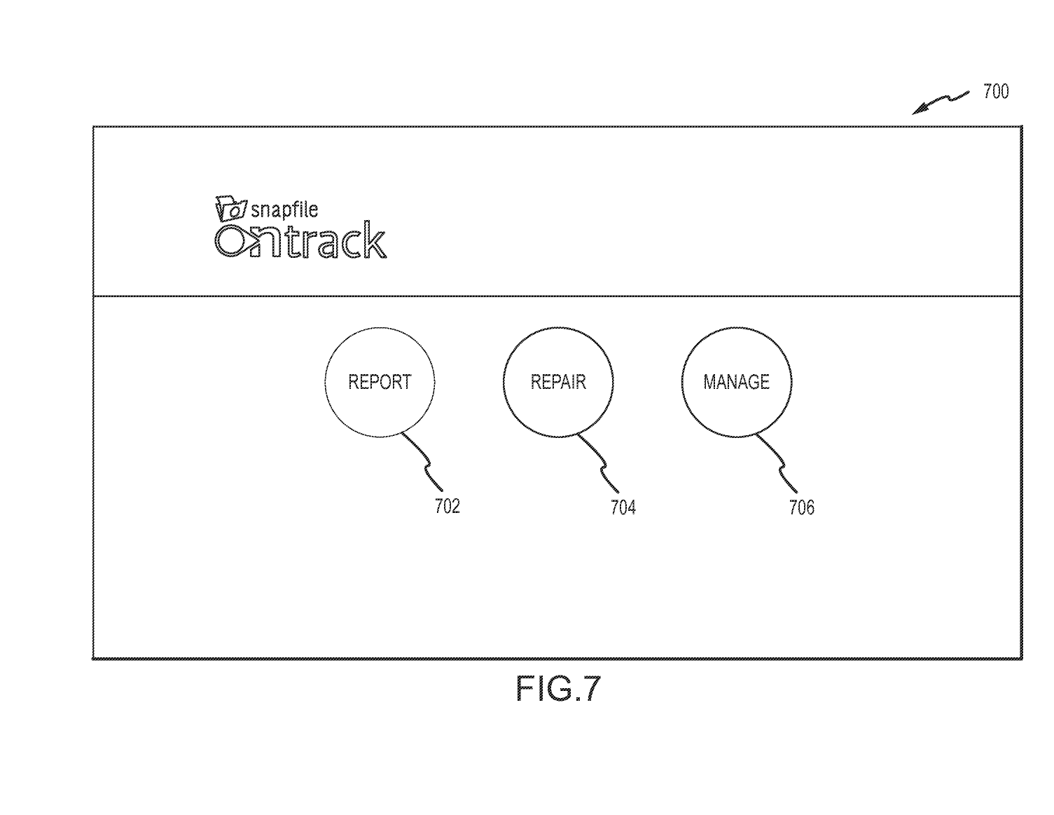

FIG. 7 is another illustration of a GUI 700 that allows a user to select a button 702-706. A button selected can depend on a function a user desires the application to perform. For example, a user can select button 706 to manage the information file.

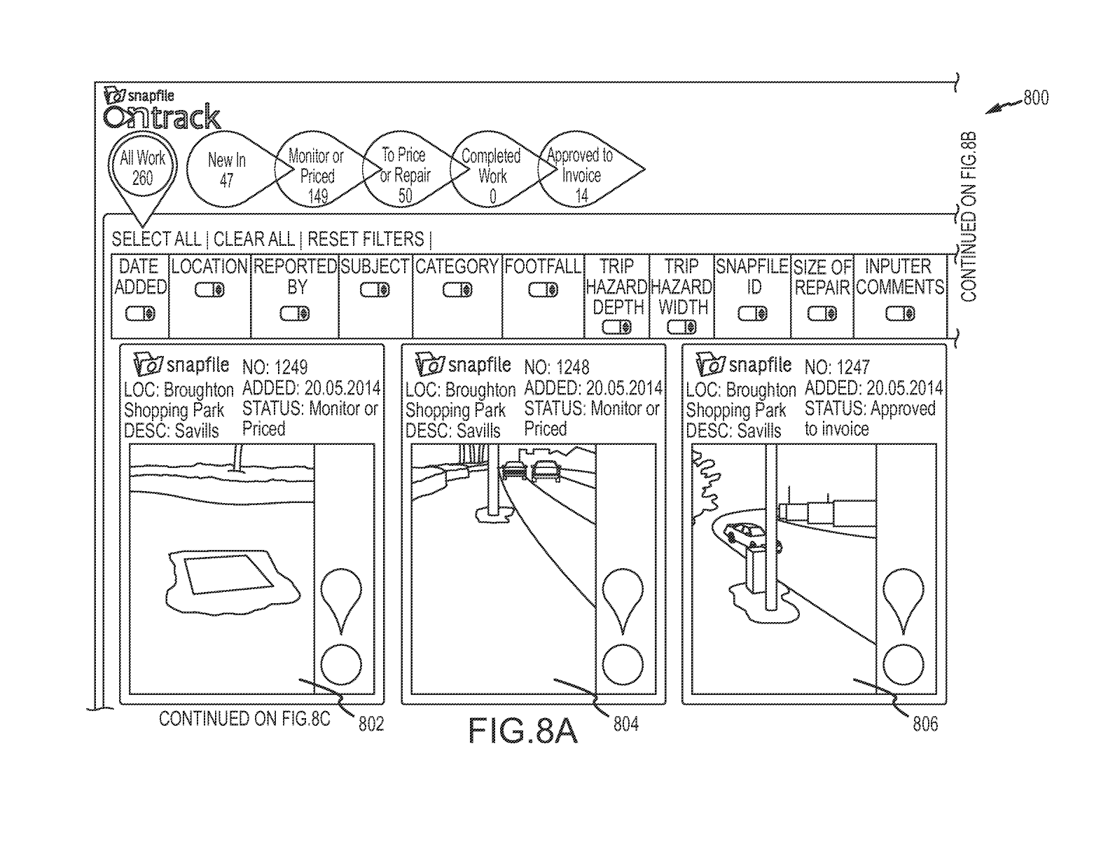

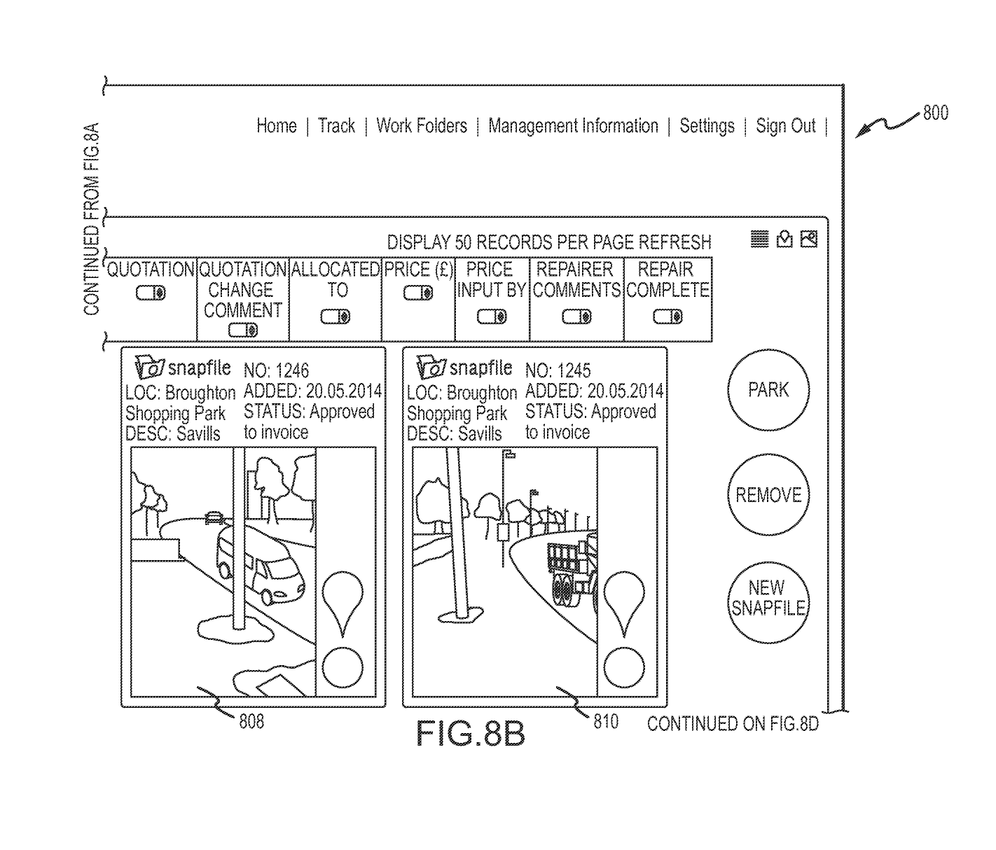

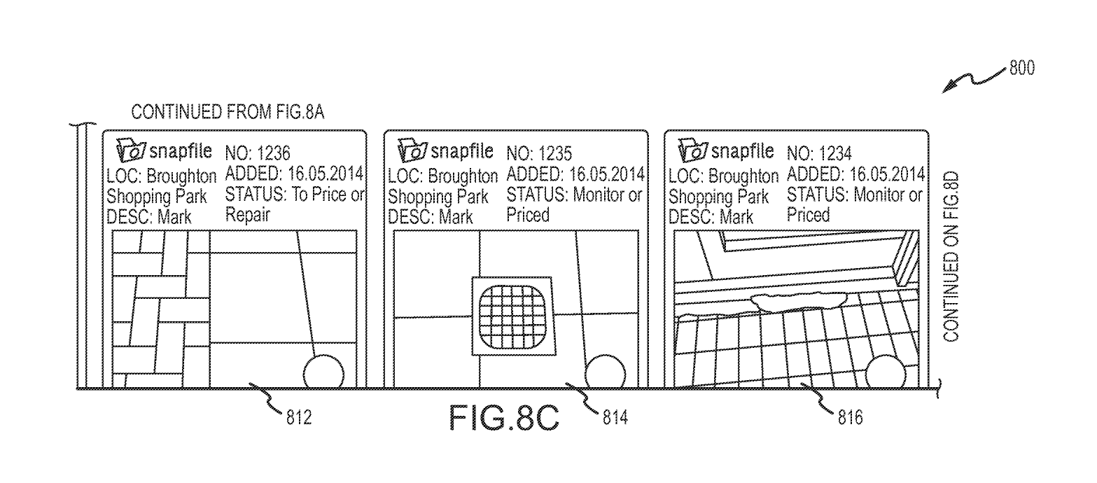

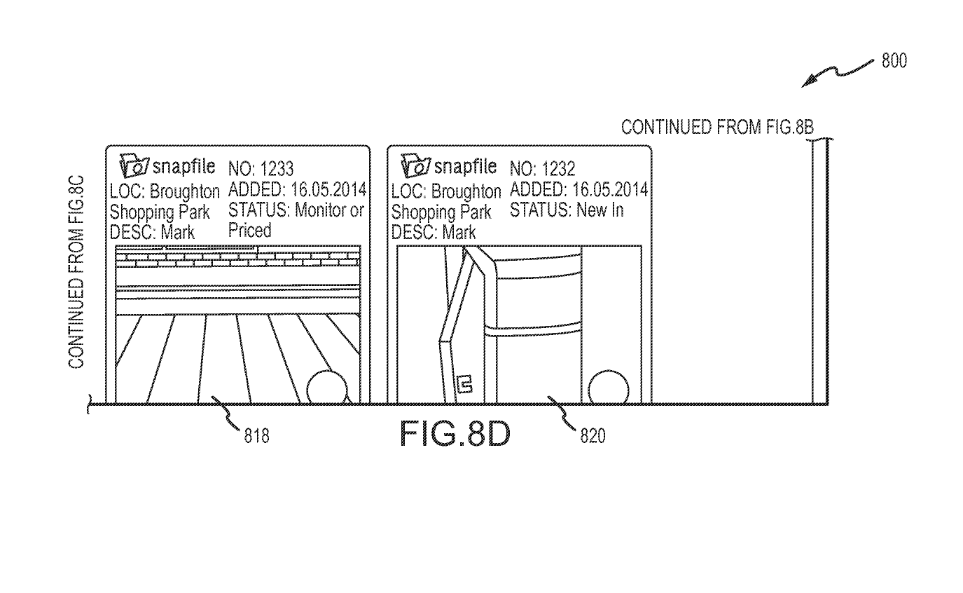

FIGS. 8A-8D illustrate a screen image 800 displaying snapshots of various information files 802-820. A particular snapshot can be selected to obtain further information regarding that file.

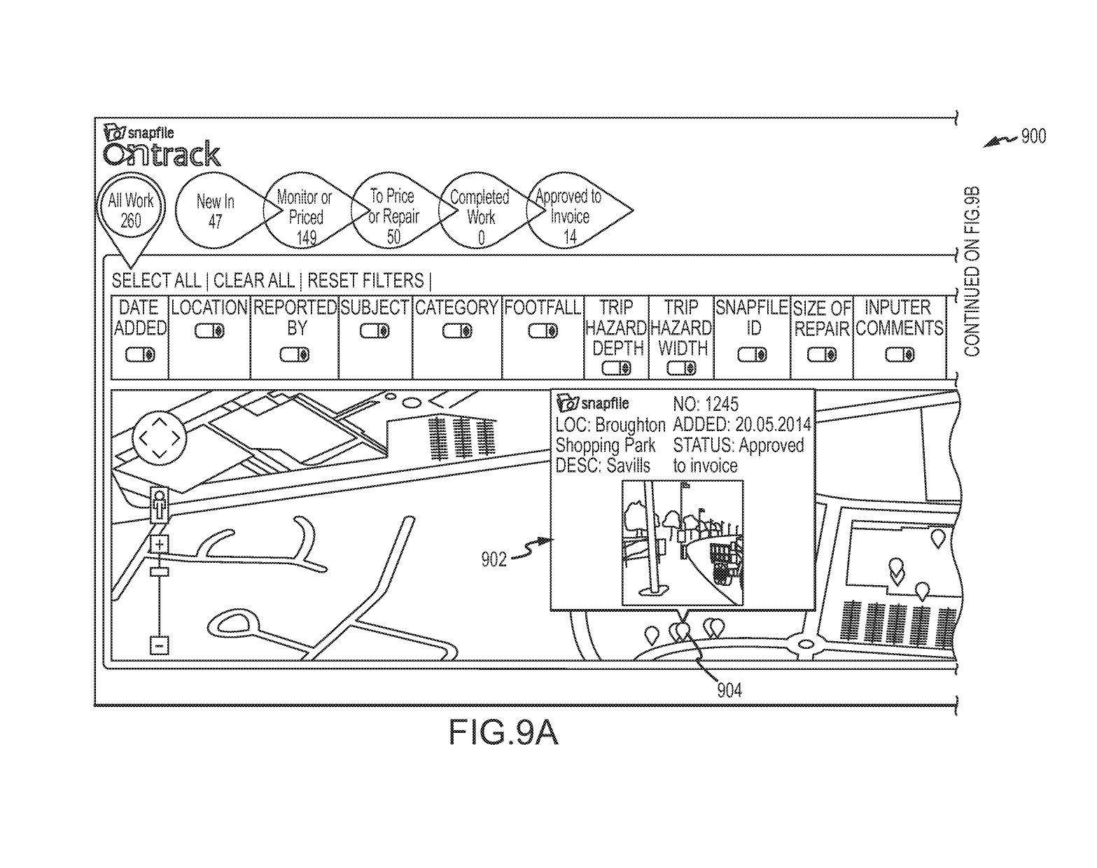

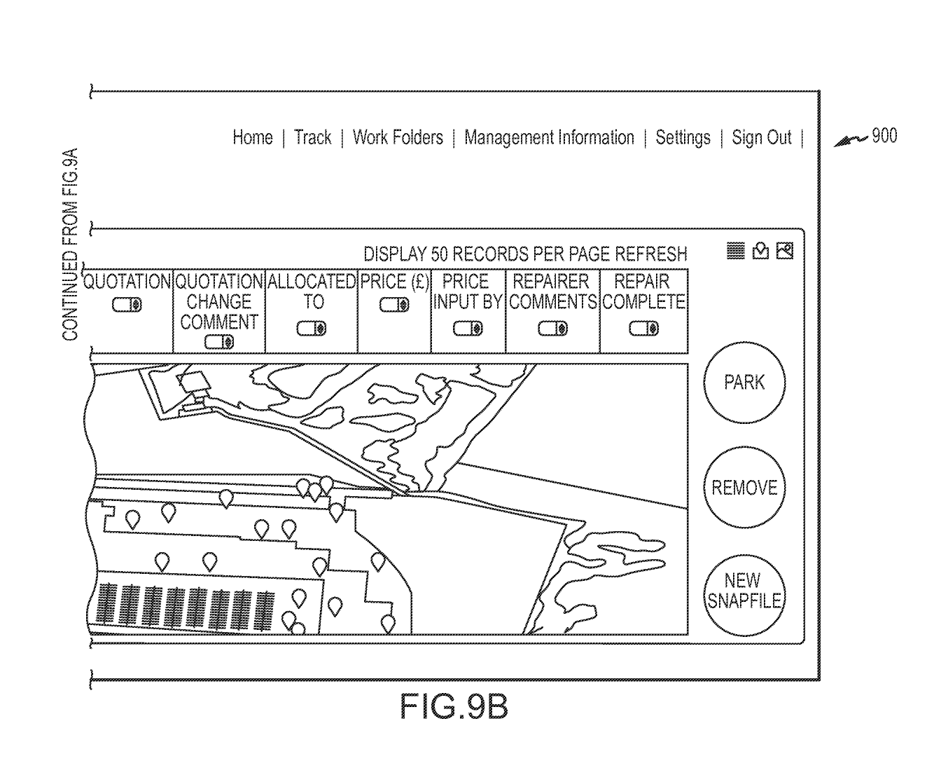

FIGS. 9A and 9B illustrate a GUI 900, where additional information 902 is displayed by placing a cursor over a spot indicated in the GUI (e.g., an indicator 904) and associated with an information file.

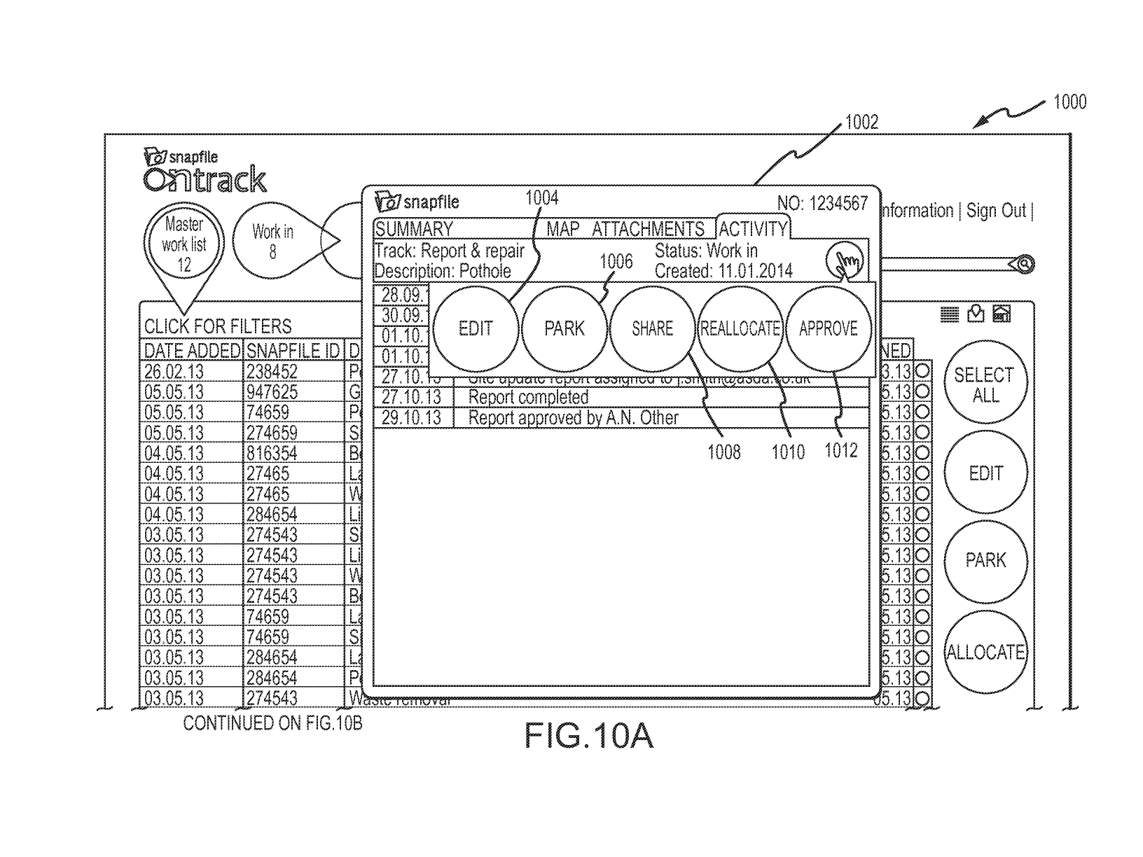

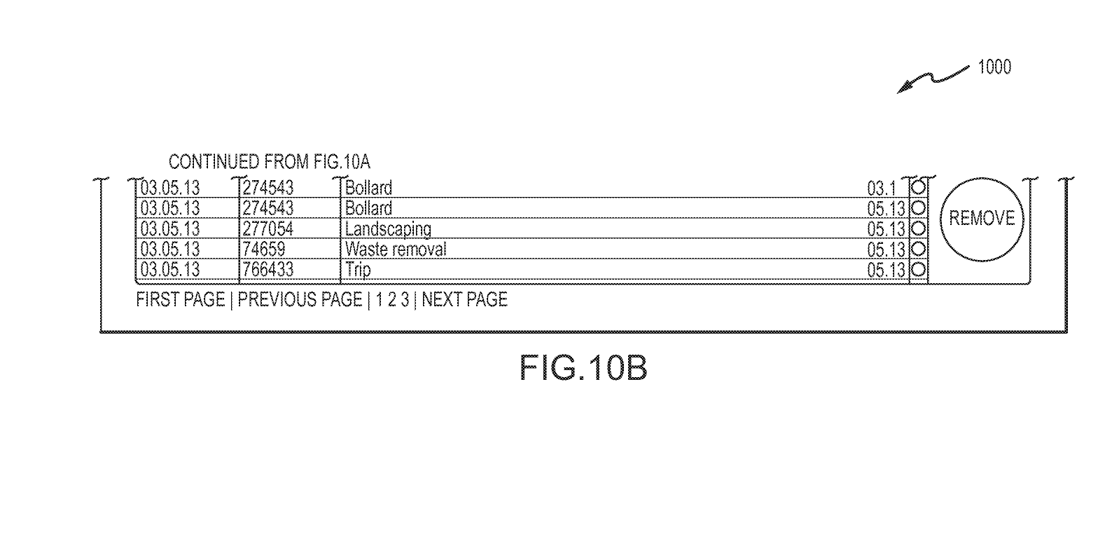

FIGS. 10A and 10B illustrate an exemplary master work list 1000. In accordance with the illustrated example, once an information file is selected, window 1002 appears, and various buttons 1004-1012, corresponding to the illustrated options, are displayed.

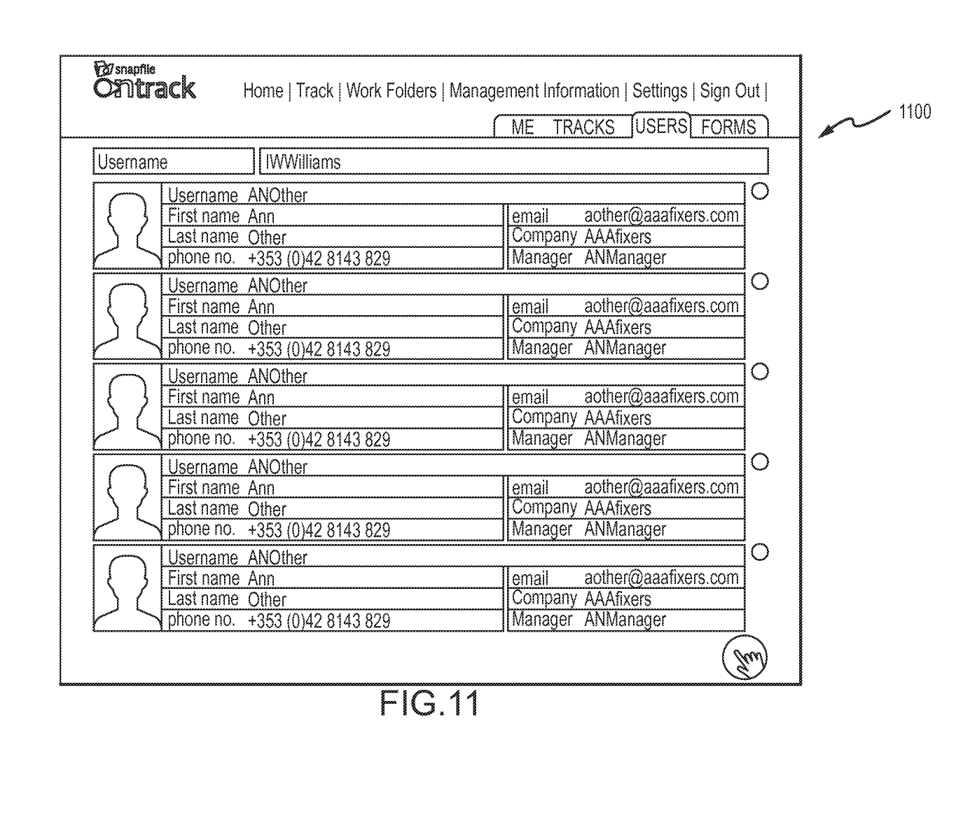

FIG. 11 illustrates a display showing a list of authorized users 1100—e.g., for a particular project file, or set of files.

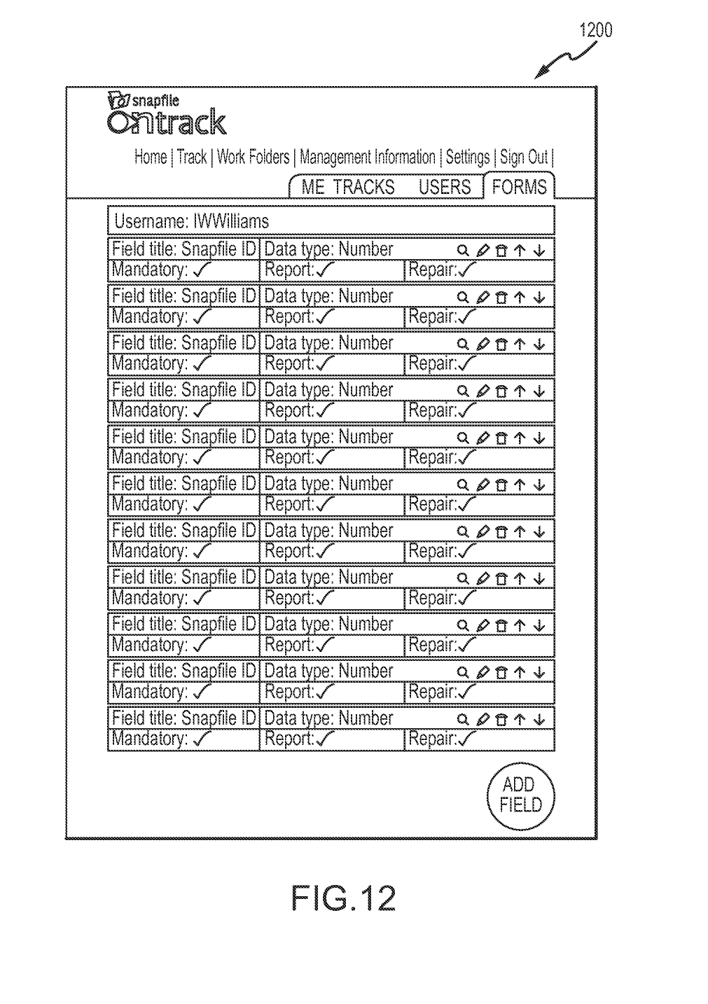

FIG. 12 illustrates a list of forms available for a project.

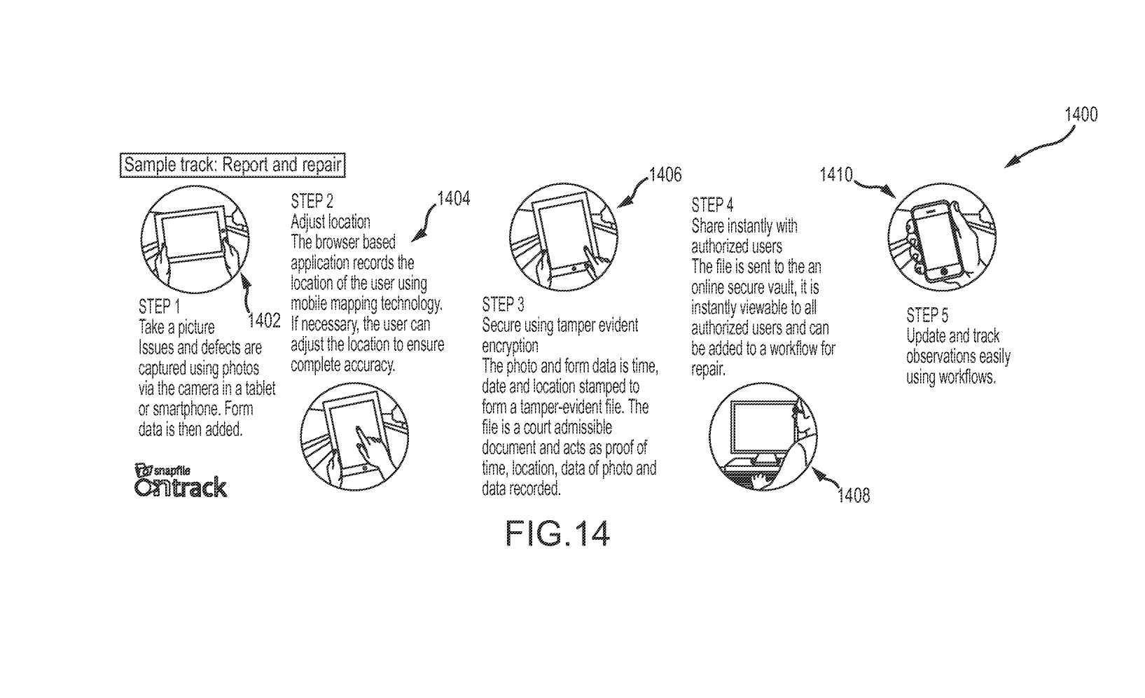

FIG. 14 illustrates a method 1400 suitable for use with mobile devices (e.g., device 102 and/or 502). The method allows for secure, web portal and mobile applications that are compatible with such devices. An authorized user can download an install an application as described herein onto a mobile device—e.g., using a browser. In accordance with some aspects, the application is responsive and optimized for screen size—e.g., built using HTML 5.

Method 1400 includes the steps of taking a picture using a mobile device (step 1402), optionally adjusting a location associated with the information (step 1404), uploading the information to a server (step 1406) into an information file as described herein, sharing the information with authorized users (step 1408), and updating/reviewing workflow (step 1410). During step 1406, the data are encrypted as described herein to form a tamper-evident file. In accordance with some aspects of these embodiments, the tamper-evident file is court-admissible and can act as proof of time, location, and date of data recorded.

As noted above, the systems and methods described herein can be used for a variety of applications, including the applications noted below and elsewhere in this disclosure. The disclosure is not limited to such applications.

### Exemplary Applications

Medical Records
   Patient identification data, lab results, patient history, medication use history, etc.
   Big benefit: use of an architecture, once associated with a patient in a hospital/clinic setting, can help ensure that the correct information is obtained and orders are given for the right patient (e.g., a doctor orders administration of a drug, the order is saved within the file, and at the patient's bedside, a real-time authentication call to the stored information is made, confirming the bar code on the nurse's pill pack).
   Selective access allows insurance companies to get medical claim processing information without accessing other sensitive patient information. Patient could provide a unique key that would support claim coverage unobtrusively.
   Documenting surgeries for transparency and malpractice avoidance.
      Video can be exported from the surgeons camera to e.g., a desktop and then uploaded to a server—e.g., using information management software. The API can be configured to integrate with different camera manufacturers to make transferring the video information easier. Another possibility could be to stream and record directly into a container (information file) on a server. These and other embodiments may be particularly useful with wearable devices, such as Google Glass or the like.
   Lab Testing. Exemplary systems and methods can standardize the documentation process in labs and similar industries where regular testing is an everyday occurrence.
Insurance Industry
   Two-way casualty data management and verification (allows later proof that the insured were or were not committing fraud).
   Provides incentives to keep the insured honest.
   Provides assurance to insured that insurance companies aren't cheating by deflating damage claims.
   SnapProof. If an insurance company wanted proof of damage—they would send the claimant an information file and claimants would use that to store authenticable data. The information file becomes the basis for proof going forward. Process: Insurer create an information file, places in it a claim number and claimant identifying information, sends to claimant's phone, claimant answers questions into the information file, claimant takes photos stored in the file, then it sends the file back. That could be especially useful for small claims. In this case, a method and system as described herein can be used to perform work previously performed by a field assessor.
Legal/forensic/evidentiary
   Police, investigators, courts, governments all need to have a data format that can ensure the integrity and authenticity of collected and stored data.
      Real-time collection, such as wire taps or recordings, could be stored in a verifiable manner in the information file in real time.
   Private industry benefits as well. Security equipment firms would like to have, for instance, a security camera DVR that directly writes to the information file format, allowing data to be made tamper proof in real time, and to be later used in court without a challenge to authenticity/integrity.
   Retail/Commercial
      Examples provided address building maintenance, traffic patterns, competitive analysis, etc.
   Municipal
   Financial
      Can be used to store account information.
      Protects users large and small, and if hackers compromise a system and obtain an information file, the data is cyphertext and practically unusable.
   Construction and Asset Tracking
   Complex Data Management and Forensic-Compatible Data Gathering
      Contract negotiations can be stored in an information files including different versions, minutes of meetings and the negotiation time line. The information file can include every detail from initial concept to signed contract and the entire process can be archived at the end of the negotiation. The information file may also include collections of video, audio, documents and drawings.
      (See also hierarchy elsewhere) Adding digital signing technology to information files creates a powerful and innovative tool for workflow management both within organisations and between organisations. Once the structure of the dataset has been defined, an application can automatically record and bind events in such a manner that they can be used as evidence in court. The options provided by systems and methods as described herein with digital signing technology make the system attractive to any organisation that desires traceability, evidence of adherence to procedures, accident investigation, disaster analysis, forensic evidence, and so on.
Commercial application in Building Information Modeling (BIM). Systems and methods as described herein could be a means of establishing the lifespan of a product and its cost of ownership thereby adding extra dimensions to a product x, y, z co-ordinates—cost and time. E.g., you could work out the maintenance costs of a building. Each component could have a unique id—whether in a building or on the side of the road, e.g., pipework, wiring within the building or roadside barriers. 3-D models with each component can be recorded by using exemplary systems and methods of the disclosure.
Species auditing for Special Areas of Conservation. Species assessment evaluates population size and density, the degree of conservation of the features of the habitat that are important for the species and restoration possibilities, the degree of isolation of the population in relation to the species' natural range and a global assessment of conservation value. For illustration, this could involve recording of every, let's say, ‘pink-toed snail’ in an area designated as an SAC under the EU Habitats Directive. This work is currently done with cameras and written notes in forms on clipboards. The data collected is then input and processed on return to office.
Secure instruction to transfer monies to financial institutions using exemplary systems and methods.
Press or other photography—validation of photographs for new agencies and the like.
Service companies keeping a record of service sheets/photograph of work you were doing—proof of maintenance.
Manufacturing process—confirming that process/compliance in high value areas (air craft manufacture, pharmaceuticals, etc.)
Proof of condition of assets (e.g., car rental before and after/any capital equipment).

Further examples of the disclosure include the following.
Sets out data types that can be stored. Any suitable data type can be stored.
   Clear application: image data files.
   E.g., video streaming from an information file in a way that in real time authenticates the integrity of the data file—such application could be useful in a courtroom setting.
File versioning and secure storage
Hierarchy—an information file within an information file. Separability/scalability. Parts that could be used by multiple processors or distributed machines (e.g., server vs (e.g., mobile) device) and then later reunited/reconciled with appropriate security verification (take a piece from the socket, use it, and then reinsert in the virtual socket). This provides for security in flight vs at rest.
Security through encryption
   Encryption implementation is modular, and different algorithms may be selected based on the desired strength of protection (user/consumer/business/sensitive/military).
   Potentially within the same information file, different levels/strengths of encryption may be utilized to protect sensitive items while allowing fast access to less sensitive items.
   A public key infrastructure approach may be implemented to verify the person(s) who originated, stored, retrieved, or modified an item (information), but such architecture is optional. This may be an extra layer of authenticity verification as discussed below.
   A multi-layer approach to encryption, (or in one embodiment, digital digests/signatures) provides a hierarchical protection paradigm, where an item as it is incrementally modified is progressively digitally signed and any subsequent signature authenticates the veracity and integrity of all previous digital signatures.
      In one example, the information file is itself multiply protected. Sign the base data, change, sign and keep going. Each onion skin wraps the others. The file has to unpeel each layer one at a time, and verify each one before it proceeds. This allows detection of just where something went wrong and cannot be authenticated and illustrates the point in the audit trail where something was interfered with.
   Self-destruct/kill switch approach. E.g., when a request is made to access data within an information file, it is temporarily encrypted with a session-unique password, so that if the access was deemed to be unauthorized (e.g., through a password/token/biometric failure) the data becomes useless. Or, false data could be provided in a disinformation defense. This can be user selectable as to how much or whether it is implemented.
Extensibility and Adaptations to External Systems
   The information file architecture is intended for use with both proprietary access tools and for external applications that may access data or features of the information file through defined application programming interfaces (APIs).
      All basic features and security can be managed through API calls.
      A software development kit (an SDK) may be produced to allow developers to quickly add code around information file access to their codebase.
      A simple reader can be utilized to grant “read only” access, and different security levels may grant progressive access as needed.
      An information file writer can be used as a standalone application or as a module called through an API to perform the appropriate changes within the information file itself.

Various Examples of the disclosure provide.
Data Security
   Integrity Verification—proving that the item in the file is the genuine item, complete and unaltered, not tampered with, not manipulated, or otherwise changed.
      Comprehensive User Access logs, audit trails, and change histories keep track of what changed, who changed it, and when it was changed.
         Encrypted information to prevent tampering, these logs may be retrieved from the information file by a user with sufficient access privileges.
      Selective user access levels (with appropriate ACL structures (header of an access control list)) govern who has access to what data items (it need not be an all or nothing access proposition) but also what kind of access is granted (privileges to read, modify, write, create, delete, etc. may be assigned to users and for specific data items as desired).
         Even the existence of data items may be suppressed in the file, so that only certain users (by access level or assigned direct file management privileges) may be aware that certain data items exist within the information file.
      An application/API may be invoked to verify the integrity of any data item in the file, and similarly, a data item that is outside the file may be verified that it matches an item that is stored within the file (and attributes of the in-file item will be provided for reference).
   Authenticity Verification—proving that the data is an accurate representation.
      Secure Metadata. Appropriate metadata may be stored in accompanying metadata files (or in the case of a Jpeg image, perhaps within an EXIF layer, or in any data item that allows nondestructive concomitant storage, within the item itself), and such files may optionally be encrypted and resistant to tampering.
         Metadata contains creation/origination data, including the author/creator, creation time/date/location, etc., that provides information allowing the end user to authenticate the representation.
      Watermarking. Images may be securely watermarked with identifying information that provides suitable information to verify authenticity.
         Stenographic methods may allow the surreptitious storing of authenticity information, source/origin information, or even access history such as the identity of a user who retrieved the item from the information file. A separate application may decode the stenographic metadata and provide the appropriate information.
      Redlining Application—allows comparison of an item within the information file to any other item (including within the information file) to identify what changed between the two. In the event the files are digital images, for example, a redlined “area” could be defined that showed what differs between the two images (and if nothing changed, a notification that the two items are functionally identical).
      Time Stamp Storage/Retrieval/Verification. Data items stored within the information file may have associated with them a plurality of time stamps that could be verified and that indicate the progress of the item through its life cycle was authentic. E.g., if a job is done, undone, redone, sequence of events is recorded and verifiable, digital signatures (or other secure metadata) at each time phase securely protects each item.
      Binding to Author/Creator. Exemplary methods and systems include binding/associating the items stored to the person originating/storing the items. Window-based authentication: if you verify yourself to your phone, then as long as you are moving for a certain period of time, data gathered and stored is successfully bound to your identify as creator.
         Post-hoc authentication can prevent access to an information file slowing down the user, and appropriate items gathered/stored within a particular window can be updated as authentic some reasonable period after the storage time.
         Variable Confidence Levels. Authenticity of data or binding/associating to creator may vary through a confidence level score maintained along with the data. A score may be modified to higher confidence later if, for example, data was found to be authentic through post-hoc authentication. Or lower if unauthorized access was attempted a predetermined number of times—e.g., 1, 2, 3, or more times.
         Binding/associating may be accomplished through ready biometric data
         Take a picture of yourself
         Scan fingerprint/ear print by placing phone to face
         Voice
         Breath
         Retinal
         Iris
         Such binding/associating biometric information could be encoded right into the data, e.g., a fingerprint shown on an image, encoded via steganography, or encoded metadata signed with the file.
Related Functionality
   Device (e.g., mobile)/distributed processing features
      Data can be checked in/out securely, processed locally, and then securely checked back into a master an information file.
      HTML browser/cloud-based synchronization and information file reconciliation.
      Real time secure access to an information file through APIs called in a cloud storage implementation.
   Process Management
   Integration of field data with information file architecture
      GPS fixing, asset identification, and management by location and visual data.
   Use of EXIF layers for data storage and image authentication
      Store a digital signature into the EXIF, store an image in the layer, take a picture of the whole thing, produce a digital signature of the whole thing in the watermark. Then the signed image file goes back to the server. Signature is embedded in the picture and stored on the server as well.
When a user presses the ‘take photo’ button control is transferred to an operating system API so our software can no longer read the orientation or location. The API (on, for example, an Apple device) records the orientation, location and several other items of data but these are not exposed to users until the image is saved. This may not be done if one wants to reduce the image size. Reducing the image size generally means that one loses the Exif data.
We can access the memory location of the image data before it is written to memory (e.g., disc) which means we can extract the Exif data and re-insert it later. This means we would have access to the following non-exhaustive list: Manufacturer, model, orientation (rotation), date and time (original and digitized), resolution, compression, exposure, f-number, focal length, maker note, interoperability, Exif version, GPS tag version, GPSVersionID, GPSLatitudeRef, GPSLongitudeRef, GPSAltitudeRef, GPS time (atomic clock), GPSTimeStamp, GPSMeasureMode, GPSSpeedRef, GPSTrackRef, GPSImgDirectionRef, GPSMapDatum, GPSDestBearingRef, GPSProcessingMethod, GPSDateStamp, and GPS differential correction.
Image resolution can be increased (e.g., doubled) by means of linear interpolation

Exemplary systems and methods allow users to easily view and prioritize work. For example, workflow can be viewable in list, map and photo format, and can be color coded according to criteria, such as severity. Additionally or alternatively, systems and methods can be used to prepare reports (e.g., with photos), showing issues, locations, status and categories. Exemplary systems can be used for enhanced costing, budgeting, and time management. Further, exemplary systems and methods can be used to audit and report on proof of work completed to implement best practices. Exemplary methods and systems can also be used to coordinate compliant and informed communications with interested parties.

### EXAMPLES OF THE DISCLOSURE

The below exemplary methods and systems can be used with the various applications described above. The below methods and systems are not limited to the applications provided herein.

### Examples

1. A method of securely storing information on a server, the method comprising the steps of

obtaining information on a device;

establishing a secure connection between the device and the server;

uploading information from the device to the server;

verifying the information;

adding a digital signature to the information.

2. The method of example 1, wherein the device is a mobile device.
3. The method of any of examples 1-2, wherein the device comprises a camera.
4. The method of any of examples 1-3, wherein the step of verifying comprises comparing a clientside hash and a serverside hash.
5. The method of any of examples 1-4, further comprising a step of creating a visible watermark associated with the information.
6. The method of any of examples 1-5, further comprising a step of creating an invisible watermark associated with the information.
7. The method of any of examples 1-6, wherein the information comprises digital photograph information.
8. The method of any of examples 1-7, wherein the information comprises digital video information.
9. The method of any of examples 1-8, wherein the information comprises EXIF information.
10. The method of any of examples 1-9, further comprising digitally signing information having one or more previous digital signatures.
11. The method of any of examples 1-10, wherein different grades of security can be assigned to the information.
12. The method of any of examples 1-11, wherein different grades of security can be assigned to the information based on a token.
13. The method of any of examples 1-12, wherein different grades of security can be assigned to the information based on a user.
14. The method of any of examples 1-13, further comprising a step of destroying the information if an attempt at unauthorized access is made.
15. The method of any of examples 1-14, further comprising a step of rendering false information if an attempt at unauthorized access is made.
16. The method of any of examples 1-15, wherein the method is used to store medical records.
17. The method of any of examples 1-16, wherein the method is used to store insurance records.
18. The method of any of examples 1-17, wherein the method is used to store legal records.
19. The method of any of examples 1-18, wherein the method is used to store financial records.
20. The method of any of examples 1-19, wherein the method is used to audit the information.
21. The method of any of examples 1-20, wherein multiple levels of authenticity are verified.
22. A system for securely and verifiably storing information on a server, the system comprising:

a server; and

one or more devices coupled to the server, wherein the one or more devices comprise a client capable of:
establishing a secure connection between the device and the server;
uploading information from the device to the server, and

wherein the server comprises an application capable of:
verifying the information; and
adding a digital signature to the information.
   23. The system of example 22, wherein the device is a mobile device.
   24. The system of any of examples 22-23, wherein the device comprises a camera.
   25. The system of any of examples 22-24, wherein the step of verifying comprises comparing a clientside hash and a serverside hash.
   26. The method of any of examples 22-25, wherein the application creates a visible watermark associated with the information.
   27. The system of any of examples 22-26, wherein the application creates an invisible watermark associated with the information.
   28. The system of any of examples 22-27, wherein the information comprises digital photograph information.
   29. The system of any of examples 22-28, wherein the information comprises digital video information.
   30. The system of any of examples 22-29, wherein the information comprises EXIF information.
   31. The system of any of examples 22-30, wherein the application further digitally signs information having one or more previous digital signatures.
   32. The system of any of examples 22-31, wherein different grades of security are assigned to the information.
   33. The system of any of examples 22-32, wherein different grades of security are assigned to the information based on a token.
   34. The system of any of examples 22-33, wherein different grades of security are assigned to the information based on a user.
   35. The system of any of examples 22-34, wherein the application executes a step of destroying the information if an attempt at unauthorized access is made.
   36. The system of any of examples 22-35, wherein the application renders false information if an attempt at unauthorized access is made.
   37. The system of any of examples 22-36, wherein the information comprises medical records.
   38. The system of any of examples 22-37, wherein the information comprises insurance records.
   39. The system of any of examples 22-38, wherein the information comprises legal records.
   40. The system of any of examples 22-39, wherein the information comprises financial records.
   41. The system of any of examples 22-40, wherein the application verifies multiple levels of authenticity.
   42. A method of storing information in a tamper-evident manner, the method comprising the steps of:

calculating a clientside hash for the information,

asynchronously uploading the information and the clientside hash,

decrypting the information on the server and calculating a serverside hash of the decrypted information; and

comparing the serverside hash with the clientside hash.

43. The method of example 42, further comprising the step of breaking information into smaller packets or blobs.
44. The method of any of examples 42-43, further comprising a step of adding additional information/data.
45. The method of any of examples 42-44, wherein the step of asynchronously uploading the information and hash does not include using http headers.
46. The method of any of examples 42-45, wherein the clientside hash is about 16 bytes.
47. The method of any of examples 42-45, wherein the clientside hash is about 20 bytes.
48. The method of any of examples 42-47, wherein the information includes one or more of video and photograph, and wherein an information file including the information includes an additional layer of security.
49. The method of any of examples 42-48, wherein the information includes one or more of video and photograph, and wherein an image or video is resized.
50. The method of any of examples 42-49, further comprising adding a visible watermark to the information.
51. The method of any of examples 42-50, further comprising adding an invisible watermark to the information.
52. The method of example 51, wherein the invisible watermark includes a digital signature.
53. The method of any of examples 42-52, wherein a signature is inserted on the server as an information file is being created.
54. The method of any of examples 42-53, further comprising a step of saving the information in a digital container.
55. The method of any of examples 42-54, further comprising creating a datastack.
56. The method of any of examples 42-55, further comprising creating a digital signature using a private key.
57. The method of any of examples 42-56, further comprising verifying a signature.
58. The method of any of examples 42-57, further comprising saving a signature.
59. The method of any of examples 42-58, further comprising destroying a datastack.
60. The method of any of examples 42-59, further comprising sending an error message.

Although exemplary embodiments of the present disclosure are set forth herein, it should be appreciated that the disclosure is not so limited. Various modifications, variations, and enhancements of the exemplary systems and methods set forth herein may be made without departing from the spirit and scope of the present disclosure.

The subject matter of the present disclosure includes all novel and nonobvious combinations and subcombinations of the various systems, components, and configurations, and other features, functions, acts, and/or properties disclosed herein, as well as any and all equivalents thereof.

We claim:

1. A method of securely storing information on a server, the method comprising the steps of
obtaining information on a device;
establishing a secure connection between the device and the server;
uploading information from the device to the server;
verifying the information; and
adding a digital signature to the information.

2. The method of claim 1, wherein the device is a mobile device.

3. The method of claim 1, wherein the step of verifying comprises comparing a clientside hash and a serverside hash.

4. The method of claim 1, further comprising a step of creating a visible watermark associated with the information.

5. The method of claim 1, further comprising a step of creating an invisible watermark associated with the information.

6. The method of claim 1, wherein the information comprises digital photograph information.

7. The method of claim 1, wherein the information comprises digital video information.

8. The method of claim 1, further comprising digitally signing information having one or more previous digital signatures.

9. The method of claim 1, wherein multiple levels of authenticity are verified.

10. A system for securely and verifiably storing information on a server, the system comprising:
a server; and
one or more devices coupled to the server, wherein the one or more devices comprise a client capable of:
establishing a secure connection between the device and the server; and
uploading information from the device to the server,
wherein the server comprises an application capable of:
verifying the information; and
adding a digital signature to the information.

11. The system of claim 10, wherein the step of verifying comprises comparing a clientside hash and a serverside hash.

12. The method of claim 10, wherein the application creates a visible watermark associated with the information.

13. The system of claim 10, wherein the application creates an invisible watermark associated with the information.

14. The system of claim 10, wherein the application further digitally signs information having one or more previous digital signatures.

15. The system of claim 10, wherein different grades of security are assigned to the information.

16. A method of storing information in a tamper-evident manner, the method comprising the steps of:
calculating a clientside hash for the information,
asynchronously uploading the information and the clientside hash,
decrypting the information on the server and calculating a serverside hash of the decrypted information; and
comparing the serverside hash with the clientside hash.

17. The method of claim 16, further comprising the step of breaking the information into smaller packets.

18. The method of claim 16, further comprising a step of adding additional data to the information.

19. The method of claim 16, wherein the information includes one or more of video and photograph, and wherein an information file including the information includes an additional layer of security.

20. The method of claim 16, wherein a signature is inserted on the server as an information file is being created.
